(19) United States
(12) Patent Application Publication
(10) Pub. No.: US 2026/0054720 A1
(43) Pub. Date: Feb. 26, 2026

(54) METHOD AND APPARATUS FOR DETERMINING A LATERAL OFFSET OF AN OBJECT

(71) Applicants: HYUNDAI MOTOR COMPANY, Seoul (KR); KIA CORPORATION, Seoul (KR)

(72) Inventor: Jae Kyun Kim, Hwaseong-si (KR)

(73) Assignees: HYUNDAI MOTOR COMPANY, Seoul (KR); KIA CORPORATION, Seoul (KR)

(21) Appl. No.: 19/225,818

(22) Filed: Jun. 2, 2025

(30) Foreign Application Priority Data
Aug. 22, 2024 (KR) 10-2024-0112652

(51) Int. Cl. B60W 30/095

(52) U.S. Cl. CPC B60W 30/0953; B60W 30/0956

(57) ABSTRACT

A method for determining a lateral offset between a vehicle and an object includes obtaining driving information of the vehicle and position information of the object. The position information of the object includes the coordinates of the object with respect to a reference coordinate system at the current time. The method also includes determining a y-axis coordinate of the vehicle when the vehicle has moved to the x-axis coordinate of the object using a driving trajectory approximation that represents a lateral travel distance as a function of a longitudinal travel distance of the vehicle. The driving trajectory approximation is determined based on a small angle approximation and an assumption that the yaw rate and the speed of the vehicle are constant. The method also includes determining the lateral offset using the y-axis coordinate of the vehicle and the y-axis coordinate of the object.

### CROSS-REFERENCE TO RELATED APPLICATION

This application claims priority to Korean Patent Application No. 10-2024-0112652, filed on Aug. 22, 2024 in the Korea Intellectual Property Office, the entire contents of which are incorporated herein by reference.

### TECHNICAL FIELD

The present disclosure relates to a method and an apparatus for calculating a lateral offset of an object. More specifically, the present disclosure relates to a method and an apparatus for calculating the lateral offset of an object in proximity to a vehicle using an approximation that replaces square root operations, thereby eliminating the needs for square root operations.

### BACKGROUND

The matters described in this Background section are only for enhancement of understanding of the background of the disclosure, and should not be taken as acknowledgement that they correspond to prior art already known to those of ordinary skill in the art.

Autonomous vehicles equipped with lidar sensors express object information in the form of point cloud data and transmit information on the shape and position of the object through a plurality of points. To determine the possibility of collision between the autonomous vehicle and a particular point, lateral offset between the vehicle and the point should be calculated, which involves square root operations.

However, square root operation requires a large amount of computation, which greatly increases the computation time and the use of computational resources of the autonomous driving system. Moreover, floating point and square root operations are often unsupported in the Micro Controller Unit (MCU) controller environments.

Therefore, various methods have been devised to perform square root operations within a short time period using a small amount of computational resources. For example, the Babylonian algorithm sets an initial guess and repeatedly performs four arithmetic operations to obtain an approximate value of the square root. The Babylonian algorithm iterates arithmetic operations to find square roots. The Babylonian algorithm may obtain increasingly accurate square root values by reducing the error between its output and the actual square root through iterations of the four arithmetic operations. However, power consumption increases as the number of repetitions of the four arithmetic operations increases. Applying the Babylonian algorithm, which requires repeated execution of the four arithmetic operations, is challenging for low-power systems. Also, the Babylonian algorithm has a problem in that the computation time increases in proportion to the number of repetitions of the four arithmetic operations, making it unsuitable for systems that require high-speed operation.

### SUMMARY

Point cloud data consists of thousands of points. To efficiently calculate the lateral offsets for the point cloud data, an alternative method to perform square root operations is required.

Objects of the present disclosure are to provide a method and an apparatus for replacing square root operations using small angle approximation and symmetric transformation.

Further objects of the present disclosure are to provide a method and an apparatus for calculating lateral offsets without involving square root operations.

Technical objects to be achieved by the present disclosure are not limited to those described above. Other technical objects not mentioned above may also be more clearly understood from the detailed descriptions given below by those of ordinary skill in the art to which the present disclosure belongs.

An embodiment of the present disclosure provides a method for calculating a lateral offset between a vehicle and an object. The method includes obtaining driving information of the vehicle and position information of the object using at least one sensor included in the vehicle. The position information of the object includes the coordinates (x_{obj}, y_{obj}) of the object with respect to a reference coordinate system at the current time. The method also includes calculating a y-axis coordinate yₛᵥ of the vehicle when the vehicle has moved to the x-axis coordinate x_{obj} of the object using a driving trajectory approximation that represents a lateral travel distance as a function of a longitudinal travel distance of the vehicle. The driving trajectory approximation is determined based on a small angle approximation and an assumption that the yaw rate and the speed of the vehicle are constant. The method further includes calculating the lateral offset using the y-axis coordinate yₛᵥ of the vehicle and the y-axis coordinate y_{obj} of the object.

Another embodiment of the present disclosure provides an apparatus for calculating a lateral offset between a vehicle and an object. The apparatus includes at least one memory storing commands and at least one processor. The at least one processor executes the commands to obtain driving information of the vehicle and position information of the object using at least one sensor included in the vehicle. The position information of the object includes the coordinates (x_{obj}, y_{obj}) of the object with respect to a reference coordinate system at the current time. The at least one processor also executes the commands to determine the y-axis coordinate yₛᵥ of the vehicle when the vehicle has moved to the x-axis coordinate x_{obj} of the object using a driving trajectory approximation that represents a lateral travel distance according to a longitudinal travel distance of the vehicle. The driving trajectory approximation is determined based on small angle approximation and an assumption that the yaw rate and the speed of the vehicle are constant. The at least one processor further executes the commands to determine the lateral offset using the y-axis coordinate yₛᵥ of the vehicle and the y-axis coordinate y_{obj} of the object.

According to one embodiment of the present disclosure, lateral offsets may be calculated without performing square root operations.

The advantageous effects of the present disclosure are not limited to those described above. Other advantageous effects of the present disclosure not mentioned above may be understood more clearly by those having ordinary skill in the art from the descriptions given below.

### BRIEF DESCRIPTION OF THE DRAWINGS

FIG. 1 is a block diagram illustrating a lateral offset calculation apparatus according to one embodiment of the present disclosure.

FIGS. 2A and 2B illustrate a method for calculating an approximate value of the lateral offset by a lateral offset calculation apparatus according to one embodiment of the present disclosure.

FIG. 3 illustrates a method for calculating an approximate value of the lateral offset by a lateral offset calculation apparatus according to one embodiment of the present disclosure when small angle approximation is not applicable.

FIG. 4 is a flow diagram illustrating a process of calculating a lateral offset approximate value by a lateral offset calculation apparatus according to one embodiment of the present disclosure.

FIG. 5 is a block diagram illustrating an example computing device that may be used for implementing the method or the apparatus according to the present disclosure.

### DETAILED DESCRIPTION

Hereinafter, some embodiments of the present disclosure are described in detail with reference to the accompanying drawings. In the following description, like reference numerals designate like elements, even when the elements are shown in different drawings. Further, in the following description of some embodiments, a detailed description of known functions and configurations incorporated therein has been omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’, ‘has’, or ‘comprises’ a component, the part is meant to further include other components, not to exclude such other components, unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe example embodiments of the present disclosure. The detailed description is not intended to represent the only embodiments in which the present disclosure may be practiced. When a component, device, unit, module, controller, apparatus or the like of the present disclosure is described as having a purpose or performing an operation, function, or the like, the component, device, unit, module, controller, or apparatus should be considered herein as being “configured to” meet that purpose or to perform that operation or function.

Lateral offset D_{Lat} according to the present disclosure refers to the distance between a vehicle and an object (or a point included in a point cloud data) in a direction perpendicular to the driving direction of the vehicle. The disclosed apparatus and method are useful, particularly in self- or autonomous-driving modes of a vehicle, or in an autonomous driving vehicle, to aid the vehicle in avoiding collisions with objects near or proximate to the vehicle or along the driving path of the vehicle. The apparatus and method can be used to determine the likelihood of a collision with an object and to then adjust the driving characteristics of the vehicle to avoid a collision. Information and/or control signals can be transmitted to driving systems of the vehicle, such as a braking system, a steering system, a motivation system (i.e., motor, engine, and/or power supply), and/or the like to operate the vehicle in a manner so as to avoid a collision.

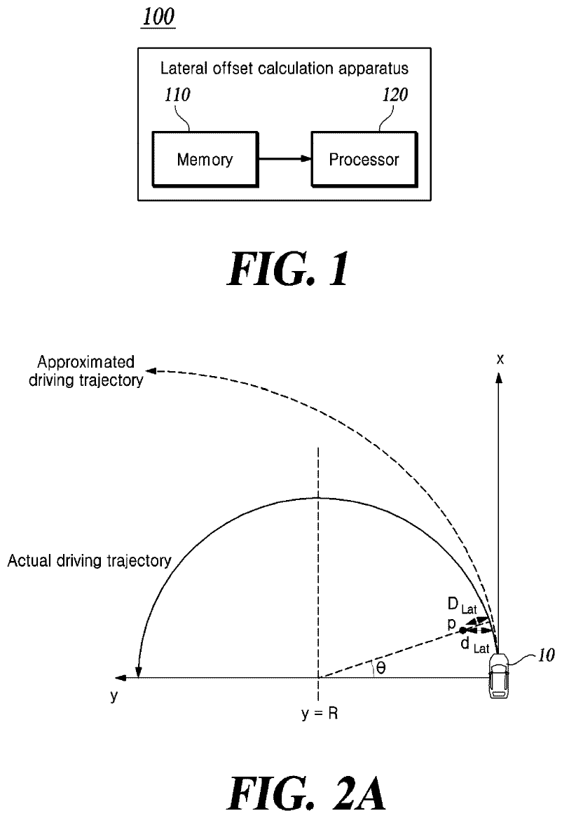

FIG. 1 shows a block diagram of a lateral offset calculation apparatus according to one embodiment of the present disclosure.

The lateral offset calculation apparatus 100 includes a memory 110 and a processor 120. The lateral offset calculation apparatus 100 may be implemented in the form of an electronic device within an embedded device, a server, or an autonomous navigation system. Not all blocks shown in FIG. 1 are essential components. A portion of blocks included in the lateral offset calculation apparatus 100 may be added, modified, or deleted in other embodiments. Meanwhile, the constituting elements shown in FIG. 1 represent functionally distinct elements. At least one constituting element may be implemented in a form in which it is integrated with another element in the actual physical environment.

The memory 110 stores data and commands required for the operation of the lateral offset calculation device 100.

The memory 110 may store driving information of the vehicle acquired using at least one sensor included in the vehicle. The driving information of the vehicle may include the position, speed, acceleration, steering angle, steering angular velocity, heading angle, and/or yaw rate of the autonomous driving vehicle.

The memory 110 may store the position information of an object acquired using at least one sensor included in the vehicle. The position information of the object may include the object's position, speed, and other related data. The position information of the object may be expressed as point cloud data. The point cloud data is obtained when an object is sensed by a lidar sensor and/or other similar devices and consists of a collection of points or data points. Information on the object, such as the shape and position of the object, may be represented through point cloud data.

The position of the object (or point) may be expressed as coordinates (x_{obj}, y_{obj}) in a reference coordinate system at the current time where the vehicle is located at the origin of the reference coordinate system. The x-axis coordinate x_{obj} is the distance between the object and the vehicle measured along the driving direction of the vehicle. The y-axis coordinate y_{obj} is the distance between the object and the vehicle along the direction perpendicular to the driving direction of the vehicle.

The processor 120 controls the overall operation of the lateral offset calculation apparatus 100. The processor 120 may be implemented as one or more processors. The processor 120 may execute commands stored in the memory 110.

The processor 120 may determine an approximation of a trajectory along which the vehicle is driving using the vehicle's driving information and employing the small angle approximation. Equation 1 (Eq. 1) represents an approximation of a vehicle's driving trajectory according to the present disclosure.

$${y}_{sv} = \frac{1}{2} ρ {x}_{sv}^{2} \qquad [ Eq . 1 ]$$

In Eq. 1, xₛᵥ represents the x-axis coordinate of the vehicle, yₛᵥ represents the y-axis coordinate of the vehicle, and ρ represents the curvature of the trajectory along which the vehicle is driving.

If the vehicle speed is V, and the heading angle of the vehicle is θ, the vehicle speed along the x-axis vₓ is obtained as vₓ=V*cos θ≈V according to the small angle approximation. Also, the vehicle speed along the y-axis v_{y} is obtained as v_{y}=V*sin θ≈V*θ according to the small angle approximation. Assuming that the yaw rate of the vehicle γ is constant, since θ=γ*t, a relationship holds so that v_{y}=V*γ*t. By integrating v_{y} with respect to time, Eq. 1 may be derived. Since a person of ordinary skill in the art to which the present disclosure belongs may easily derive Eq. 1 by integrating the vehicle speed along the y-axis v_{y}, a detailed derivation process has been omitted.

The processor 120 may approximately calculate the vehicle's travel distance along the y-axis according to the vehicle's travel distance along the x-axis using Eq. 1.

The processor 120 may determine the approximate value d_{Lat} of the object's lateral offset using Eq. 1 and the object's position information. Equation 2 (Eq. 2) is an approximation for finding square roots, which uses Eq. 1 for calculating the approximate value d_{Lat} of the lateral offset according to the present disclosure.

$${d}_{Lat} = {y}_{obj} - {y}_{sv} ( {x}_{obj} ) = {y}_{obj} - \frac{1}{2} ρ {x}_{obj}^{2} \qquad [ Eq . 2 ]$$

In Eq. 2, x_{obj} represents the x-axis coordinate of the object, and y_{obj} represents the y-axis coordinate of the object. By inserting the object's x-axis coordinate x_{obj} into the approximate equation of the driving trajectory, the processor 120 obtains the approximate value yₛᵥ(x_{obj}), which represents the vehicle's travel distance when the vehicle has traveled a distance of x_{obj}. The processor 120 determines the difference between the object's y-axis coordinate y_{obj} and the vehicle's y-axis coordinate yₛᵥ(x_{obj}) as the approximate value d_{Lat} of the object's lateral offset.

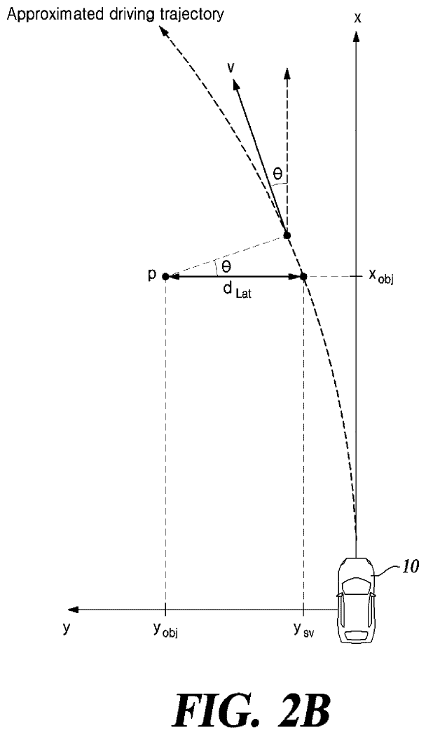

FIGS. 2A and 2B illustrate a method for calculating an approximate value d_{Lat} of the lateral offset of a point included in a point cloud by a lateral offset calculation apparatus 100 according to one embodiment of the present disclosure.

In FIG. 2A, p represents a target point for which the lateral offset D_{Lat} is to be calculated and the coordinates of the target point are (x_{obj}, y_{obj}). The current position of the vehicle 10 is (0, 0), and R represents the radius of curvature of the trajectory along which the vehicle 10 is driving. In FIG. 2A, d_{Lat} represents an approximate value of the lateral offset D_{Lat} that is to be calculated using a method according to the present disclosure. Also, θ represents the angle formed by a straight line passing through (0, R) and (x_{obj}, y_{obj}) relative to the y-axis and is equal to the heading angle of the vehicle 10 at the position where the lateral offset D_{Lat} is to be calculated. It is assumed that 0 is close to 0 to allow small angle approximation to be applied.

FIG. 2B is an enlarged view of a portion of FIG. 2A where the target point p is located. In FIG. 2B, v represents the speed of the vehicle 10 at the target position, and V represents the magnitude (|v|) of the vehicle speed v.

By using Eq. 1, the lateral offset calculation apparatus 100 calculates the y-axis travel distance yₛᵥ of the vehicle when the vehicle's travel distance along the x-axis is x_{obj}. The lateral offset calculation apparatus 100 calculates an approximate value d_{Lat} of the lateral offset by inserting the y-axis coordinate y_{obj} of the target point p and the vehicle's y-axis travel distance yₛᵥ into Eq. 2. The lateral offset calculation apparatus 100 calculates d_{Lat} as an approximate value of the lateral offset D_{Lat} for the target point p.

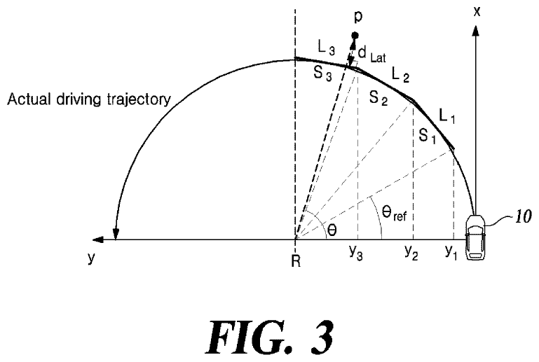

FIG. 3 illustrates a method for calculating an approximate value d_{Lat} of the lateral offset by the lateral offset calculation apparatus 100 according to one embodiment of the present disclosure and when small angle approximation is not applicable. In FIG. 3, R is the radius of curvature of a trajectory along which the vehicle 10 is driving and p is a target point.

The lateral offset calculation apparatus 100 determines whether θ is less than or equal to a preconfigured reference angle θ_{ref}. The reference angle θ_{ref} may be set to the maximum angle at which the small angle approximation may be applied.

The lateral offset calculation apparatus 100 divides the driving trajectory of the vehicle 10 into one or more segments when θ exceeds the preconfigured reference angle. FIG. 3 shows a case where the lateral offset calculation apparatus 100 divides the driving trajectory of the vehicle 10 into three segments (S₁-S₃). The lateral offset calculation apparatus 100 determines first-order approximations (L₁-L₃) that approximate the driving trajectory curve of the vehicle as a straight line for each segment. The number of segments can vary from the three segments shown and described for this example.

The lateral offset calculation apparatus 100 determines the segment S₃ to which the target point p belongs among a plurality of segments (S₁-S₃). In one embodiment, the lateral offset calculation apparatus 100 may determine the segment to which the target point p belongs by determining whether the y-axis coordinate y_{obj} of the target point p falls within the y-axis range (y₁-y₂, y₂-y₃, y₃-R) of each segment.

The lateral offset calculation apparatus 100 calculates a straight-line distance d_{Lat} from the first-order approximation L₃ of the segment to which the target point p belongs to the target point p. The lateral offset calculation apparatus 100 uses the corresponding straight-line distance d_{Lat} as an approximate value of the lateral offset D_{Lat} for the target point p.

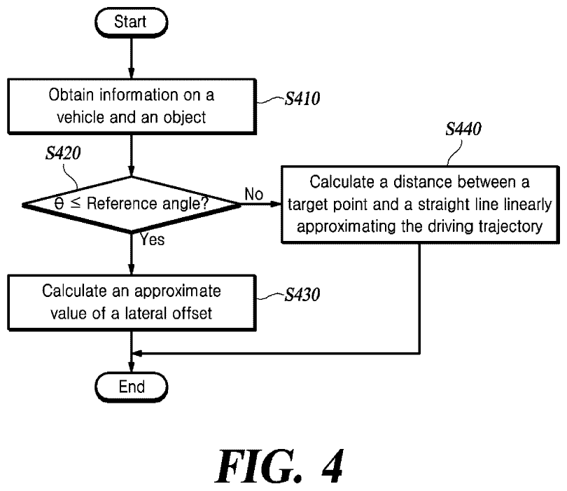

FIG. 4 is a flow diagram illustrating a process of calculating a lateral offset approximate value by the lateral offset calculation apparatus 100 according to one embodiment of the present disclosure.

The lateral offset calculation device 100 obtains driving information of the vehicle and position information of the object using one or more sensors included in the vehicle 10 (operation S410). The driving information of the vehicle may include the velocity, acceleration, steering angle, steering angular velocity, heading angle, and/or yaw rate of the vehicle. The position information of the object may include the position, speed, and other related information of the object. The position information of the object may be expressed as point cloud data. The point cloud data is obtained when an external object of the vehicle is sensed, and the point cloud data is expressed as a collection of points. Information on the object, such as the shape and position of the object, is expressed through point cloud data.

The lateral offset calculation apparatus 100 determines whether θ is less than or equal to a preconfigured reference angle θ_{ref} (operation S420). The lateral offset calculation apparatus 100 calculates an approximate value d_{Lat} of the lateral offset for the target point p using Eq. 2 when θ is less than or equal to a preconfigured reference angle θ_{ref} (operation S430).

The lateral offset calculation apparatus 100 divides the driving trajectory of the vehicle 10 into one or more segments when θ exceeds the preconfigured reference angle. The lateral offset calculation apparatus 100 determines first-order approximations that approximate the driving trajectory curve of the vehicle as a straight line for each segment.

The lateral offset calculation apparatus 100 determines the segment to which the target point p belongs among a plurality of segments. The lateral offset calculation apparatus 100 calculates a straight-line distance d_{Lat} from the first-order approximation of the segment to which the target point p belongs to the target point p. The lateral offset calculation apparatus 100 uses the corresponding straight-line distance d_{Lat} as an approximate value of the lateral offset D_{Lat} for the target point p (operation S440).

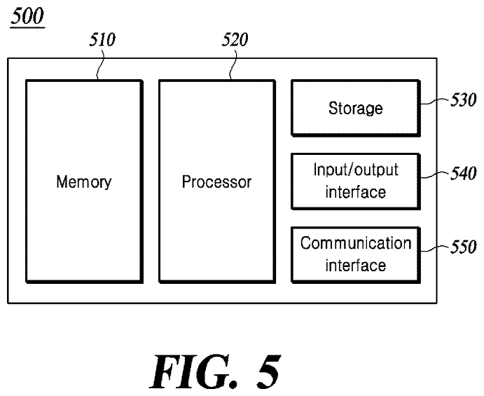

FIG. 5 is a block diagram of an example computing device that may be used for implementing the method or the apparatus according to the present disclosure.

The computing device 500 may include all or part of a memory 510, a processor 520, storage 530, an input/output interface 540, and a communication interface 550. The computing device 500 may structurally and/or functionally include at least a portion of the lateral offset calculation apparatus. The computing device 500 may be a stationary computing device, such as a desktop computer or a server, as well as a mobile computing device, such as a laptop computer, a smartphone, or an automotive electronic device. The computing device 500 may be implemented as an arbitrarily specialized hardware accelerator capable of efficiently processing operations devised for an artificial intelligence model. For example, the computing device 500 may include a graphics processing unit (GPU), a Tensor Processing Unit (TPU), or a neural processing unit (NPU).

The memory 510 may store a program that enables the processor 520 to perform methods or operations according to various embodiments of the present disclosure. For example, a program may include a plurality of instructions executable by the processor 520. The methods or operations described above may be performed by executing the plurality of instructions by the processor 520. The memory 510 may consist of a single memory or a plurality of memories. In this case, information required to perform the methods or operations according to various embodiments of the present disclosure may be stored in a single memory or distributed across a plurality of memories. When the memory 510 is composed of a plurality of memories, the plurality of memories may be physically separated. The memory 510 may include at least one of volatile memory and non-volatile memory. Volatile memory includes Static Random Access Memory (SRAM) or Dynamic Random Access Memory (DRAM), while non-volatile memory includes flash memory.

The processor 520 may include at least one core capable of executing at least one instruction. The processor 520 may execute instructions stored in the memory 510. The processor 520 may consist of a single processor or a plurality of processors.

The storage 530 maintains stored data even if power supplied to the computing device 500 is cut off. For example, the storage 530 may include non-volatile memory or may include a storage medium such as a magnetic tape, an optical disk, or a magnetic disk. A program stored in the storage 530 may be loaded into the memory 510 before being executed by the processor 520. The storage 530 may store files written in a program language, and a program created from the files by a compiler may be loaded into the memory 510. The storage 530 may store data to be processed by the processor 520 and/or data processed by the processor 520.

The input/output interface 540 may provide an interface with an input device such as a keyboard or a mouse and/or an output device such as a display device or a printer. The user may trigger execution of a program by the processor 520 through the input device and/or check the processing results of the processor 520 through the output device.

The communication interface 550 may provide access to an external network. The computing device 500 may communicate with other devices through the communication interface 550.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this description is merely an example of the technical idea of embodiments of the present disclosure. In other words, those having ordinary skill in the art to which embodiments of the present disclosure belong may appreciate that various modifications and changes can be made without departing from essential features of an embodiment of the present disclosure. For example, the sequence illustrated in the flowcharts/timing charts can be changed and one or more operations of the operations can be performed in parallel. Thus, flowcharts/timing charts are not limited to the temporal order.

Although example embodiments of the present disclosure have been described for illustrative purposes, those of ordinary skill in the art should appreciate that various modifications, additions, and substitutions are possible, without departing from the idea and scope of the claims. Therefore, example embodiments of the present disclosure have been described for the sake of brevity and clarity. The scope of the technical idea of the present embodiments is not limited by the illustrations. Accordingly, one of ordinary skill should understand that the scope of the claims is not to be limited by the above explicitly described embodiments but by the claims and equivalents thereof.

What is claimed is:

1. A method for determining a lateral offset between a vehicle and an object, the method comprising:
obtaining driving information of the vehicle and position information of the object using at least one sensor included in the vehicle, wherein the position information of the object includes the coordinates (x_{obj}, y_{obj}) of the object with respect to a reference coordinate system at a current time;
determining a y-axis coordinate yₛᵥ of the vehicle when the vehicle has moved to the x-axis coordinate x_{obj} of the object using a driving trajectory approximation that represents a lateral travel distance as a function of a longitudinal travel distance of the vehicle, wherein the driving trajectory approximation is determined based on a small angle approximation and an assumption that a yaw rate and a speed of the vehicle are constant; and
determining the lateral offset using the y-axis coordinate yₛᵥ of the vehicle and the y-axis coordinate y_{obj} of the object.

2. The method of claim 1, wherein the position information of the object is point cloud data comprising information on shape and position of the object, and wherein determining the lateral offset comprises calculating the lateral offset of each point of a plurality of points in the point cloud data.

3. The method of claim 1, wherein, when the object is located in an area in which the small angle approximation is not applicable, determining the lateral offset includes:
dividing the driving trajectory of the vehicle into one or more segments;
calculating first-order approximations that approximate the driving trajectory curve of the vehicle for each segment; and
calculating a distance to the object from a first-order approximation of the segment to which the object belongs.

4. The method of claim 1, wherein the driving information of the vehicle comprises a position, speed, acceleration, steering angle, steering angular velocity, heading angle, and/or yaw rate of the vehicle.

5. The method of claim 1, wherein the position information of the object comprises a position, speed data, and/or shape data of the object.

6. The method of claim 1, further comprising controlling the vehicle, based on the lateral offset, by controlling one or more driving systems of the vehicle in order to avoid a collision with the object.

7. An apparatus for determining a lateral offset between a vehicle and an object, the apparatus comprising:
at least one memory storing commands; and
at least one processor,
wherein the at least one processor is configured to execute the commands to
obtain driving information of the vehicle and position information of the object using at least one sensor included in the vehicle, wherein the position information of the object includes the coordinates (x_{obj}, y_{obj}) of the object with respect to a reference coordinate system at the current time,
determine the y-axis coordinate yₛᵥ of the vehicle when the vehicle has moved to the x-axis coordinate x_{obj} of the object using a driving trajectory approximation that represents a lateral travel distance according to a longitudinal travel distance of the vehicle, wherein the driving trajectory approximation is determined based on small angle approximation and an assumption that a yaw rate and a speed of the vehicle are constant, and
determine the lateral offset using the y-axis coordinate yₛᵥ of the vehicle and the y-axis coordinate y_{obj} of the object.

8. The apparatus of claim 7, wherein the position information of the object is point cloud data including information on a shape and a position of the object, and wherein the lateral offset is a lateral offset of each of points in the point cloud data.

9. The apparatus of claim 7, wherein, when the object is located in an area in which the small angle approximation is not applicable, the lateral offset is determined by:
dividing the driving trajectory of the vehicle into one or more segments;
calculating first-order approximations that approximate the driving trajectory curve of the vehicle for each segment; and
calculating a distance to the object from a first-order approximation of the segment to which the object belongs.

10. The apparatus of claim 7, wherein the driving information of the vehicle comprises a position, speed, acceleration, steering angle, steering angular velocity, heading angle, and/or yaw rate of the vehicle.

11. The apparatus of claim 7, wherein the position information of the object comprises a position, speed data, and/or shape data of the object.

12. The apparatus of claim 7, wherein the at least one processor is configured to execute the commands, based on the lateral offset, to control one or more driving systems of the vehicle in order to avoid a collision with the object.
